(19) United States
(12) Patent Application Publication
(10) Pub. No.: US 2010/0146276 A1
(43) Pub. Date: Jun. 10, 2010

(54) METHOD OF RECOVERING AND MANAGING SECURITY-RELATED INFORMATION FOR DOWNLOADABLE CONDITIONAL ACCESS SYSTEM

(75) Inventors: Young Ho JEONG, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(73) Assignee: Electronic and Telecommunications Research Institute, Daejeon (KR)

(21) Appl. No.: 12/607,218

(22) Filed: Oct. 28, 2009

(30) Foreign Application Priority Data
Dec. 10, 2008 (KR) 10-2008-0125150

(51) Int. Cl. H04L 9/32

(52) U.S. Cl. 713/169

(57) ABSTRACT

A method of managing security-related information in a Downloadable Conditional Access System (DCAS) is provided. The method of managing security-related information in the DCAS, the method including: receiving a request for storage of identification information and security-related information from a target server, the security-related information being required to be securely maintained; transmitting a recovery key to the target server in preparation for a loss of the security-related information in the target server; receiving a request for recovery of the security-related information from the target server, when the security-related information is lost; encrypting the security-related information of the target server using the recovery key; and transmitting the encrypted security-related information to the target server.

### CROSS-REFERENCE TO RELATED APPLICATION

This application claims priority from Korean Patent Application No. 10-2008-0125150, filed on Dec. 10, 2008, in the Korean Intellectual Property Office, the entire disclosure of which is incorporated herein by reference.

### BACKGROUND OF THE INVENTION

1. Field of the Invention

The present invention relates to a Downloadable Conditional Access System (DCAS), and more particularly, to a technology to recover and manage security-related information to prepare for a particular situation or a disaster situation.

2. Description of Related Art

When users desire to watch a specific program, a Conditional Access System (CAS) in cable networks determines whether to provide a service based on a user authentication and enables only approved user to receive the program.

In a CAS in an initial stage, each manufacturing company uses standards different from each other, and thus a CAS is not compatible with other devices excluding a device of a particular company. Accordingly, a broadcasting service provider is required to directly provide a receiving terminal to a subscriber, which imposes a heavy burden on a broadcasting service provider and causes a difficulty in updating a CAS.

The OpenCable has provided a standard separating a Conditional Access module from a subscriber terminal to overcome such a disadvantage, that is, to prevent a monopoly of manufacturing company, boost competition, and cause a decline in a product price. Accordingly, a CAS separated from a subscriber terminal is standardized as a cable card of a Personal Computer Memory Card International Association (PCMCIA) card type. Also, a broadcasting service provider provides a subscriber with only cable card without lending a terminal to a subscriber, and thereby may provide a fee-based broadcasting service. However, an expected result of OpenCable has not been achieved due to an increase in a cable card price and management cost as well as failure in a retail market of terminals.

In such a circumstance, a technology related to a downloadable CAS (DCAS) is provided. The DCAS downloads a conditional access software to a subscriber terminal without a separate hardware conditional access module, and thereby enables a fee-based broadcasting service to be provided.

A headend system in a DCAS may include a variety of servers. In this instance, each of the servers may use security-related information to obtain a secure communication channel. For example, an Authentication Proxy (AP) server may use security-related information to perform a mutual authentication with a Secure Micro (SM).

In this instance, maintaining and managing security-related information may be critical for a DCAS. In particular, when security-related information used by each server is lost due to an unpredictable situation, and the like, a technology enabling the lost security-related information to be securely recovered is required.

### SUMMARY OF THE INVENTION

The present invention provides a method of managing security-related information which may provide a protocol to securely recover lost security-related information in preparation for a loss of the security-related information.

The present invention also provides a method of managing security-related information which may separately store security-related information of a target server in preparation for a loss of the security-related information, may securely provide a recovery key to a corresponding server, and thereby may enable the target server to efficiently recover the security-related information.

According to an aspect of the present invention, there is provided a method of managing security-related information in a downloadable conditional access system (DCAS), the method including: receiving a request for storage of identification information and security-related information from a target server, the security-related information being required to be securely maintained; transmitting a recovery key to the target server in preparation for a loss of the security-related information in the target server; receiving a request for recovery of the security-related information from the target server, when the security-related information is lost; encrypting the security-related information of the target server using the recovery key; and transmitting the encrypted security-related information to the target server.

The target server may decrypt the encrypted security-related information using the recovery key to recover the lost security-related information.

According to an aspect of the present invention, there is provided a method of managing security-related information in a DCAS, the method including: storing a session key and security-related information of a target server, the session key being used by the target server and based on a predetermined security protocol, the security-related information being required to be securely maintained and being encrypted using a particular key, the session key and the encrypted security-related information being mapped to each other; transmitting a recovery key to the target server in preparation for a loss of the security-related information, encrypted using the particular key, in the target server; receiving a recovery request message about the security-related information, encrypted using the particular key, from the target server, the recovery request message including information associated with the session key; extracting the security-related information, encrypted using the particular key, using the session key-associated information included in the recovery request message; encrypting the security-related information, encrypted by the particular key, using the recovery key; and transmitting the security-related information encrypted using the recovery key to the target server.

According to the present invention, a security-related information management method may provide a protocol to securely recover lost security-related information in preparation for a loss of the security-related information.

Also, according to the present invention, a security-related information management method may separately store security-related information of a target server in preparation for a loss of the security-related information, securely provide a recovery key to a corresponding server, and thereby may enable the target server to efficiently recover the security-related information.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a Downloadable Conditional Access System (DCAS) according to an embodiment of the present invention;

FIG. 2 is a flowchart illustrating operations of entities in a DCAS according to an embodiment of the present invention;

FIG. 3 is a diagram illustrating a target server and a Local Key Server (LKS) which transmit/receive various information according to a security-related information management method, according to an embodiment of the present invention;

FIG. 4 is a diagram illustrating a target server and an LKS which transmit/receive various information according to a security-related information management method, according to another embodiment of the present invention;

FIG. 5 is a diagram illustrating an AP server, an LKS, and a Trusted authority (TA) which transmit/receive various information according to a security-related information management method, according to still another embodiment of the present invention; and

FIG. 6 is a flowchart illustrating an operation to start a recovery algorithm through an integrity check of security-related information by a target server according to an embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

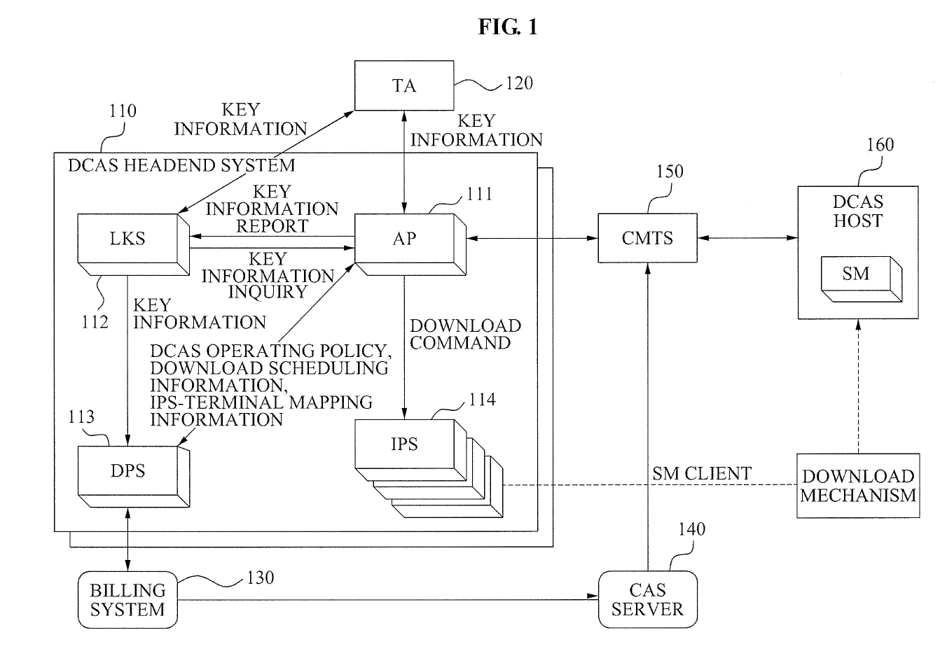

FIG. 1 is a block diagram illustrating a Downloadable Conditional Access System (DCAS) according to an embodiment of the present invention.

Referring to FIG. 1, a headend system 110 for a conditional access service may include an Authentication Proxy (AP) server 111, a Local Key Server (LKS) 112, a Downloadable Conditional Access System Provisioning Server (DPS) 113, and an Integrated Personalization System (IPS) server 114.

The headend system 110 may be installed separately from an existing Conditional Access System (CAS) server 140. Also, the headend system 110 may be operated independently from the CAS server 140, and thereby may be compatible with an existing cable broadcasting system.

The LKS 112 may store and manage information about keys of servers, such as a key of a secure micro (SM), a history of identification (ID) information of the SM, a key of the AP server 111, a history of ID information of the AP server 111, and a history of key information of the IPS server 114.

Also, the DPS 113 may determine a download policy and a policy associated with a DCAS service, and manage information associated with the policies, hereinafter, referred to as ‘download-related information’ or ‘download policy-related information’.

Also, the IPS server 114 may store and manage an SM client to be downloaded to a DCAS host 160.

When a DCAS host 160 connected to a cable network exists, the AP server 111 may transmit information associated with an SM of the DCAS host 160 to a Trusted Authority (TA) 120 to authenticate the DCAS host 160. The TA 120 may be a reliable external authentication device. The TA 120 may authenticate the DCAS host 160 using the received information associated with the SM.

The AP server 111 may receive the download-related information or the download policy-related information from the DPS 113. The download-related information or the download policy-related information may include information associated with a connection (mapping) between the IPS server 114 and DCAS host 160, information associated with a download scheme of the SM, information associated with a DCAS operating policy, and download scheduling information.

In this instance, the AP server 111 may command the IPS server 114 to perform a process to download the SM client based on the download-related information or the download policy-related information. The IPS server 114 may perform the process to download the SM client according to a download scheme corresponding to download-related information or download policy-related information selected by the DPS 113 from a plurality of download schemes. The plurality of download schemes may correspond to a variety of transfer protocols such as a Carousel, Trivial File Transfer Protocol (TFTP), Hyper-Text Transfer Protocol (HTTP), and the like.

When an authentication of the DCAS host 160 is completed, the DCAS host 160 may download and install the SM client in the SM of the DCAS host 160. The DPS 113 may report to the CAS server 140 an access authority of the authenticated DCAS host 160 to a program through a billing system 130. In this instance, the CAS server 140 may transmit an Entitlement Management Message (EMM) to the DCAS host 160 through a Cable Modem Termination System (CMTS) 150.

The SM client downloaded and installed in the SM of the DCAS host 160 may extract a code word using the received EMM through a CAS messages processing operation. Also, the SM client may transmit the extracted code word to a Transport Processor (TP). The TP may decode the encrypted and received program using the code word.

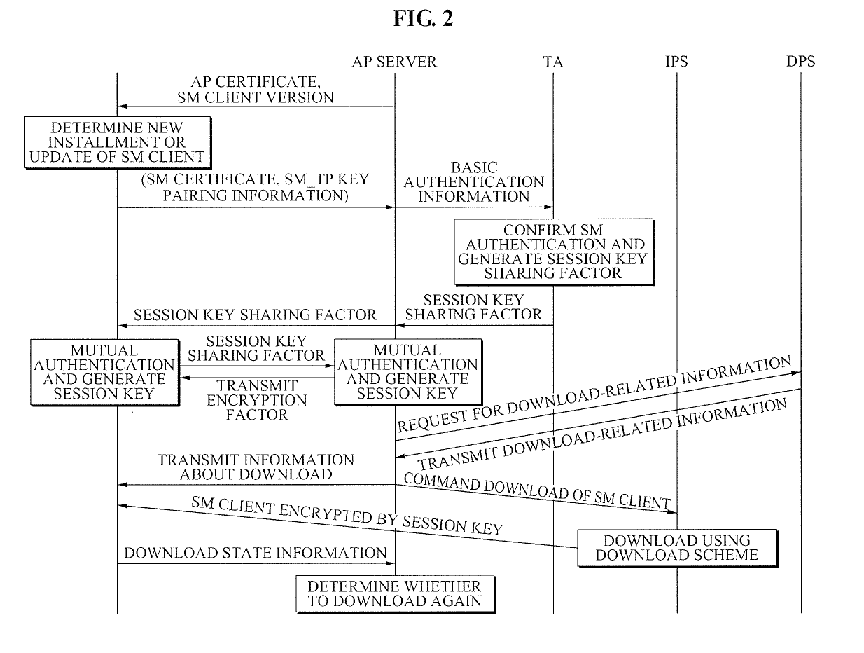

FIG. 2 is a flowchart illustrating operations of entities in a DCAS according to an embodiment of the present invention.

Referring to FIG. 2, an AP server may continuously transmit a certificate of the AP server and SM client version information to a DCAS host via a DCAS network protocol interface. The certificate of the AP server and SM client version information, currently operated, may be used to determine whether downloading of an SM client is necessary.

The certificate of the AP server may be used to authenticate a message received from the AP server by the DCAS host, and to confirm an identity of the AP server.

The DCAS host connected to a DCAS network may determine whether to newly install or update the SM client using the received SM client version information. When the SM client is determined to be newly installed or updated, the DCAS host may transmit basic authentication information to the AP server.

The basic authentication information may include information associated with a key pairing of a TP and an SM, a certificate of the SM, and the like. The certificate of the SM may be used when the AP server authenticates a message received from the DCAS host and confirms an identity of the DCAS host.

The AP server may transmit the basic authentication information to the TA, and the TA may authenticate the SM. When the authentication of the SM is completed, the AP server may generate a session key sharing factor, and transmit the generated session key sharing factor to the AP server.

The AP server may share the session key sharing factor with the DCAS host. The AP server and the DCAS host sharing the session key sharing factor may perform a mutual authentication. When the authentication is completed, each session key may be generated. The session key may be used to encrypt or decrypt a DCAS message and SM client.

The AP server may request a DPS for download-related information or download policy-related information. The download-related information or the download policy-related information may include information associated with a connection (mapping) between an IPS server and the DCAS host, information associated with an address of the IPS server, and information associated with a download scheme or a name of the SM client. The AP server may transmit the download-related information or the download policy-related information to the DCAS host.

The AP server may command the IPS server to perform a process to download the SM client according to a download scheme. The IPS server may perform the process to download the SM client according to the selected download scheme. In this instance, the downloaded SM client may be encrypted using a session key.

The DCAS host may transmit download state information to the AP server in association with whether the SM client is normally downloaded. The AP server may determine whether the SM client is to be downloaded again based on the received download state information. When it is determined that the SM client is to be downloaded again, the AP server may perform a process to download the SM client again.

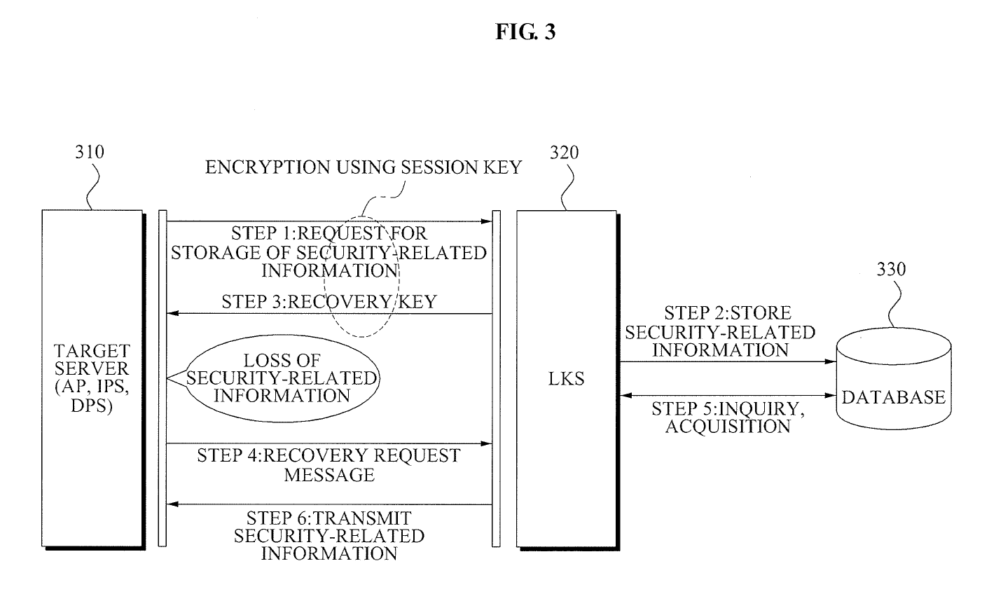

FIG. 3 is a diagram illustrating a target server 310 and an LKS 320 which transmit/receive various information according to a method of managing security-related information, hereinafter, referred to as ‘security-related information management method’, according to an embodiment of the present invention.

Referring to FIG. 3, in step 1, the target server 310 may request the LKS 320 for storage of the security-related information. In this instance, every time the security-related information is updated, the target server 310 may request the LKS 320 for storage of the updated security-related information.

The target server 310 may be any one of an AP server, an IPS server, and a DPS included in a DCAS headend system.

The security-related information may include various information. For example, security-related information managed by the AP server may include ID information of the AP server (AP_ID), private key information (AP_Private_Key), certification information (AP_Certificate), and the like. Also, security-related information managed by the AP server for an authenticated SM may include ID information of the AP server (AP_ID), ID information of an SM (SM_ID), session ID information (Session_ID), pairing information of an ID of an SM and a key provided to the SM, hardware version information (HW_Version) and software version information (SW_Version) of the SM, session key information (Session_Key), 3*RAND_TA, 3*Kc, 3*RES, Nounce_SM, and IV. Here, the 3*RAND_TA may be a factor required when the AP server or the SM generates a session key, and may be a randomly generated number provided by a TA to generate different session keys for each session. In this instance, an initial factor to generate a session key may be Ki and RAND_TA. Also, when generating the session key, 3*Kc and 3*RES may be a middle factor obtained based on Ki and RAND_TA. Also, Nounce_SM may be a random number transmitted from an SM used while generating the session key.

Also, security-related information managed by the IPS server may include ID information of the IPS server (IPS_ID), private key information of the IPS server (IPS_Private), and certificate information of the IPS server (IPS_Certificate). Also, security-related information managed by the DPS may include ID information of the DPS (DPS_ID), private key information of the DPS (DPS_Private_Key), and certificate information of the DPS (DPS_Certificate).

In step 2, the LKS 320 may store the security-related information of the target server 310 in a previously prepared database 330 in response to the request from the target server 310. In this instance, the security-related information of the target server 310 may be stored in the database 330 to enable the security-related information to be differentiated by identification information of the target server 310.

In step 3, the LKS 320 may transmit a recovery key to the target server 310 in preparation for a loss of the security-related information managed by the target server 310. That is, the target server 310 and the LKS 320 may share an identical recovery key used to recover security-related information.

In this instance, since the security-related information or key-related information of the target server 310 is not lost in step 1 and step 2, the target server 310 and the LKS 320 may use a secure security protocol such as a Secure Socket Layer (SSL) or a Transport Layer Security (TLS). Accordingly, the security-related information may be encrypted using a session key and securely transmitted to the LKS 320 from the target server 310. Also, the recovery key may be encrypted using the session key and securely transmitted to the target server 310 from the LKS 320.

It may be assumed that a disaster situation or a particular situation similar to the disaster situation occurs and the security-related information, managed by the target server 310, is lost.

In step 4, the target server 310 may request the LKS 320 for recovery of the lost security-related information using the identification information of the target server 310, for example, ID. Here, the identification information of the target server 310 may be previously provided to the LKS 320. In particular, the target server 310 may request the LKS 320 for recovery of the lost security-related information by transmitting a recovery request message, including the identification information of the target server 310, to the LKS 320.

The target server 310 may encrypt the recovery request message using the previously provided recovery key, and thereby may securely transmit the recovery request message to the LKS 320. In this instance, the recovery key may be an encryption key which is a symmetric key, such as a Data Encryption Standard (DES), a 3-DES, and an Advanced Encryption Standard (AES).

Also, the LKS 320 may decrypt the encrypted recovery request message using the recovery key, and thereby may extract the identification information of the target server 310.

In step 5, the LKS 320 may query the database 330 to retrieve identification information matching the identification information of the target server 310. Also, the LKS 320 may obtain the security-related information of the target server 310 from the database 330.

In step 6, the LKS 320 may encrypt the obtained security-related information of the target server 310 using the recovery key, and transmit the encrypted security-related information of the target server 310 to the target server 310. In this instance, the target server 310 may decrypt the security-related information, transmitted from the LKS 320, using the previously provided recovery key, and thereby may recover the lost security-related information.

Accordingly, the target server 310 and the LKS 320 may share the recovery key in advance in preparation for a loss of the security-related information due to the disaster situation, and thus the lost security-related information may be securely recovered.

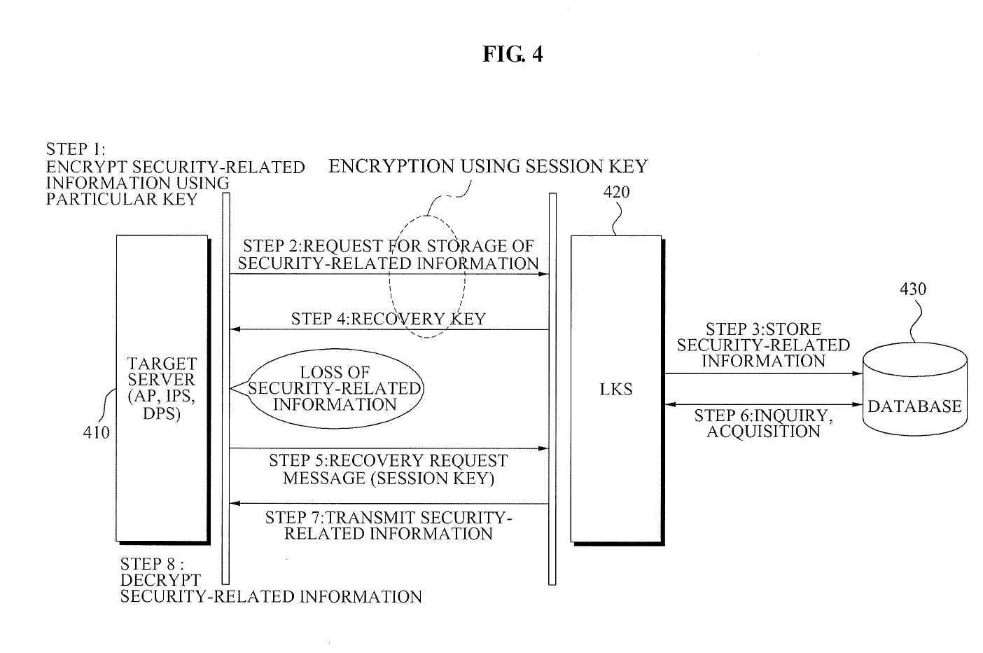

FIG. 4 is a diagram illustrating a target server 410 and an LKS 420 which transmit/receive various information according to a security-related information management method according to another embodiment of the present invention.

Referring to FIG. 4, in step 1, the target server 410 may encrypt security-related information of the target server 410 using a particular encryption key. Here, the LKS 420 may not ascertain the encryption key.

In step 2, the target server 410 may request the LKS 420 for storage of the security-related information of the target server 410. In this instance, when the security-related information is updated, the target server 410 may request the LKS 420 for storage of the updated security-related information. Here, the security-related information may be encrypted using a session key and transmitted to the LKS 420.

In step 3, the LKS 420 may store the security-related information in a database 430. In step 4, the LKS 420 may transmit a recovery key to the target server 410 in preparation for a loss of the security-related information in the target server 410. The recovery key may be an encryption key which is a symmetrical key.

In step 5, when the security-related information is lost, the target server 410 may transmit a recovery request message to the LKS 420. The recovery request message may include the session key used by the target server 410. In this instance, the target server 410 may encrypt the recovery request message using the recovery key, and securely transmit the encrypted recovery request message to the LKS 420.

In step 6, the LKS 420 may extract the session key included in the recover request message using the recovery key. Also, the LKS 420 may query the database 430 to obtain the security-related information, lost in the target server 410, using the extracted session key. Here, the database 430 may map the session key with the security-related information, and store the mapped session key and security-related information.

In step 7, the LKS 420 may transmit the obtained security-related information to the target server 410. Specifically, the LKS 420 may encrypt the security-related information using the previously provided recovery key, and thereby may securely transmit the obtained security-related information to the target server 410.

In step 8, the target server 410 may decrypt the security-related information encrypted using the recovery key. Also, the target server 410 may decrypt the security-related information using the particular encryption key used in step 1, and thereby may recover the lost security-related information.

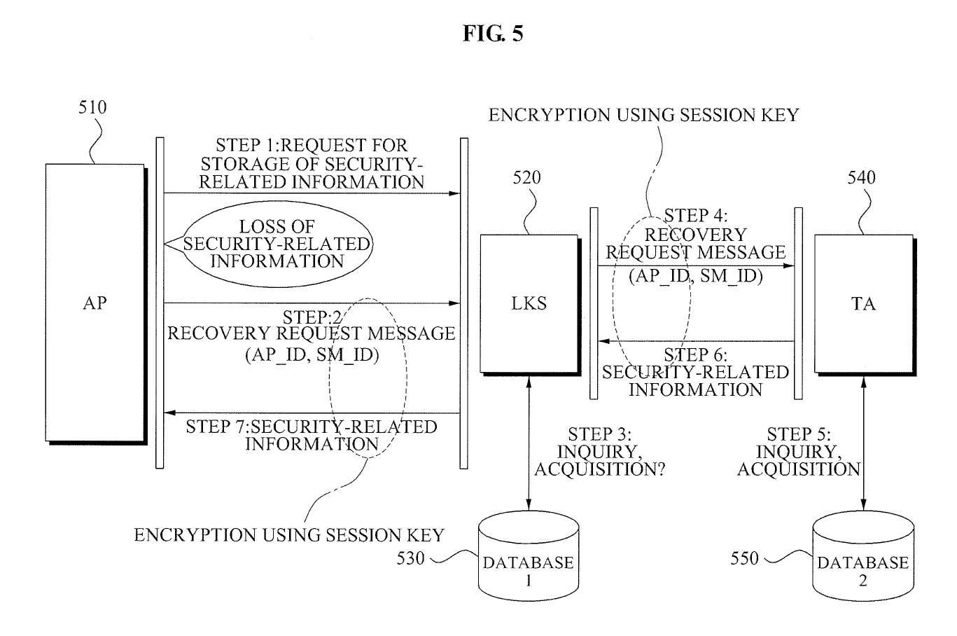

FIG. 5 is a diagram illustrating an AP server 510, an LKS 520, and a TA 540 which transmit/receive various information according to a security-related information management method according to still another embodiment of the present invention.

Referring to FIG. 5, in step 1, the AP server 510 may provide the LKS 520 with security-related information for an authenticated SM. The security-related information for the authenticated SM is not encrypted. That is, a manager of the LKS 520 may access the security-related information for the authenticated SM without limit. Specifically, the AP server 510 and the TA 540 are required to share a particular encryption key to limit an authority to access of the manager of the LKS 520, and an excessive load may be generated in the TA 540 to enable the AP server 510 and the TA 540 to share the particular encryption key.

In step 2, when the security-related information is lost, the AP server 510 may provide the LKS 520 with a first recovery request message. The first recovery request message may include identification information (AP_ID) of the AP server 510 and identification information (SM_ID) of the authenticated SM. Also, the first recovery request message may be encrypted using a session key and provided to the LKS 520.

In step 3, the LKS 520 may extract the identification information (AP_ID) of the AP server 510 and the identification information (SM_ID) of the authenticated SM included in the first recovery request message. Also, the LKS 520 may query about whether the lost security-related information is stored in a database (1) 530, using the extracted identification information (AP_ID) of the AP server 510 and the extracted identification information (SM_ID) of the authenticated SM.

In step 4, when the lost security-related information is not stored in the database (1) 530, the LKS 520 may transmit a second recovery request message to the TA 540. The second recovery request message may include the identification information (AP_ID) of the AP server 510 and the identification information (SM_ID) of the authenticated SM.

In step 5, the TA 540 may query about whether the lost security-related information is stored in a database (2) 550, using the identification information (AP_ID) of the AP server 510 and the identification information (SM_ID) of the authenticated SM. In step 6, the TA 540 may obtain the security-related information from the database (2) 550, and provide the obtained security-related information to the LKS 520.

In step 7, the LKS 520 may provide the security-related information to the AP server 510. The AP server 510 may recover the lost security-related information using the provided security-related information.

The first recovery request message, the security-related information, and the second recovery request message, transmitted in step 2, step 4, step 6, and step 7, may be encrypted using the session key and securely transmitted/received.

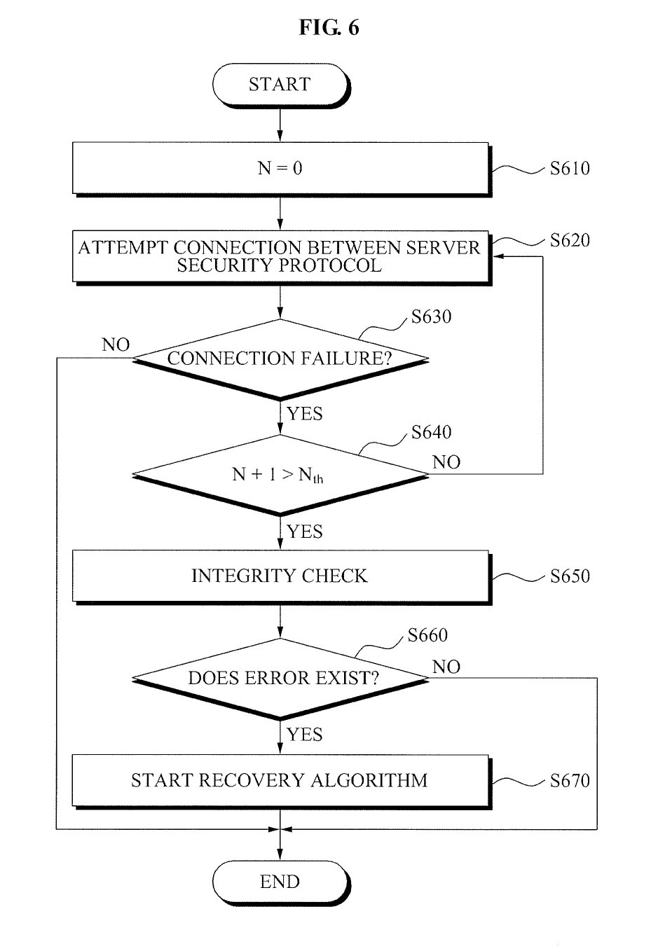

FIG. 6 is a flowchart illustrating an operation to start a recovery algorithm through an integrity check of security-related information by a target server according to an embodiment of the present invention.

Referring to FIG. 6, in operation S610, the target server may initialize N as ‘0’. N may indicate a number of connections in a utilized security protocol.

In operation S620, the target server may attempt a connection between the security protocol and at least one server from among other servers included in a DCAS network. In operation S630, the target server may determine whether the connection succeeds.

When the connection succeeds, the target server may end an algorithm illustrated in FIG. 6. However, when the connection fails, the target server may update N with N+1, and compare N+1 with a predetermined threshold value Nₜₕ in operation S640.

In operation S650, when N+1 is greater than the predetermined threshold value Nₜₕ, the target server may perform the integrity check of security-related information. Conversely, when N+1 is less than or equal to the predetermined threshold value Nₜₕ, the target server may return to operation S620. That is, the target server may attempt the connection with the security protocol the same number of times as a value of the predetermined threshold value Nₜₕ.

In operation S660, the target server may determine whether an error exists in a result of the integrity check. In operation S670, when the error exists, the target server may start a recovery algorithm. When the error does not exist, the target server may finish the algorithm illustrated in FIG. 6.

The method of managing security-related information in a DCAS according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of managing security-related information in a downloadable conditional access system (DCAS), the method comprising:
receiving a request for storage of identification information and security-related information from a target server, the security-related information being required to be securely maintained;
transmitting a recovery key to the target server in preparation for a loss of the security-related information in the target server;
receiving a request for recovery of the security-related information from the target server, when the security-related information is lost;
encrypting the security-related information of the target server using the recovery key; and
transmitting the encrypted security-related information to the target server.

2. The method of claim 1, wherein the receiving of the request for recovery of the security-related information comprises:
receiving an identifier (ID) of the target server; and
retrieving the security-related information of the target server using the ID of the target server.

3. The method of claim 1, wherein the target server encrypts the security-related information using a session key which is based on a predetermined security protocol, and
the receiving of the request for storage of the security-related information receives the request for storage of the security-related information encrypted using the session key.

4. The method of claim 1, wherein the target server receives a request for storage of updated security-related information in response to update of the security-related information.

5. The method of claim 1, wherein the target server decrypts the encrypted security-related information using the recovery key to recover the lost security-related information.

6. The method of claim 1, wherein the recovery key is an encryption key which is a symmetric key.

7. The method of claim 1, wherein the target server is any one of an Authentication Proxy (AP) server which performs a mutual authentication of a host, an Integrated Personalization System (IPS) server which manages a Secure Micro (SM) client downloaded to the host, and a DCAS Provisioning Server which manages a download policy of the SM client.

8. The method of claim 1, wherein the target server determines whether the security-related information is lost, and requests the recovery of the security-related information depending on a result of the determination.

9. The method of claim 8, wherein the target server determines whether the security-related information is lost at a predetermined time interval.

10. A method of managing security-related information in a DCAS, the method comprising:
storing a session key and security-related information of a target server, the session key being used by the target server and based on a predetermined security protocol, the security-related information being required to be securely maintained and being encrypted using a particular key, the session key and the encrypted security-related information being mapped to each other;
transmitting a recovery key to the target server in preparation for a loss of the security-related information, encrypted using the particular key, in the target server;
receiving a recovery request message about the security-related information, encrypted using the particular key, from the target server, the recovery request message including information associated with the session key;
extracting the security-related information, encrypted using the particular key, using the session key-associated information included in the recovery request message;
encrypting the security-related information, encrypted by the particular key, using the recovery key; and
transmitting the security-related information encrypted using the recovery key to the target server.

11. The method of claim 10, wherein the target server decrypts the security-related information, encrypted by the recovery key, using the recovery key and decrypts the security-related information, encrypted by the particular key, using the particular key.

12. The method of claim 10, wherein the recovery key is an encryption key which is a symmetric key.

13. The method of claim 10, wherein the predetermined security protocol is any one of a protocol based on a Secure Socket Layer (SSL) and a protocol based on a Transport Layer Security (TLS).

14. A method of managing security-related information in a DCAS, the method comprising:
receiving a request for storage of security-related information for an authenticated SM from an AP server;
receiving a first recovery request message including identification information of the AP server and identification information of the authenticated SM; and
querying a previously prepared database to extract the security-related information.

15. The method of claim 14, further comprising:
transmitting a second recovery request message, including the identification information of the AP server and the identification information of the authenticated SM, to a Trusted Authority (TA); and
receiving the extracted security-related information, when the TA extracts the security-related information using the identification information of the AP server and the identification information of the authenticated SM.

16. The method of claim 15, further comprising:
transmitting the security-related information, received from the TA, to the AP server.

17. The method of claim 15, wherein the querying queries the previously prepared database using the identification information of the AP server and the identification information of the authenticated SM.
